(19) United States
(12) Patent Application Publication
(10) Pub. No.: US 2025/0322411 A1
(43) Pub. Date: Oct. 16, 2025

(54) CONTROLLING RESOURCE TRANSFERS BASED ON RESOURCE SYSTEM WORKLOADS AND COMPLIANCE STANDARDS

(71) Applicant: Truist Bank, Charlotte, NC (US)

(72) Inventor: Prasad P. Jahagirdar, Charlotte, NC (US)

(73) Assignee: Truist Bank, Charlotte, NC (US)

(21) Appl. No.: 18/633,648

(22) Filed: Apr. 12, 2024

(51) Int. Cl. G06Q 30/018; G06Q 20/10

(52) U.S. Cl. CPC G06Q 30/018; G06Q 20/10

(57) ABSTRACT

A system can be provided for controlling resource transfers based on standard requirements. For example, the system can detect transmission of a resource request by a user device. The resource request can be a request to transfer a resource from the first user account to a second user account via a resource system. The system can further identify a standard associated with the resource system and receive real-time data from the resource system. Based on the standard and the real-time data, the system can generate a delay function that can include a duration of time. The system can then execute the delay function to delay transfer of the resource from the first user account to the second user account via the resource system for the duration of time.

### TECHNICAL FIELD

The present disclosure relates generally to secure resource transfers and, more particularly (although not necessarily exclusively), to controlling resource transfers based on resource system workloads and compliance standards.

### BACKGROUND

Resource systems may facilitate transfers of resources. Examples of the resource systems may include mobile banking applications, Automated Clearing House, online payment services (e.g., Zelle), peer-to-peer payment systems (e.g., Apple Pay), wire transfer channels, or the like. In some examples, the resource systems can be used for performing data (e.g., electronic fund) transfers between user accounts associated with one or more entities (e.g., financial institutions). Additionally, user profiles can be associated with the user accounts, and users can be authenticated based on information in the user profiles. For example, authentication with a user account can enable a user (e.g., an external client of the entity) to monitor data transfers performed via one or more resources systems with respect to the user account, initiate the data transfers, or perform other suitable operations.

### SUMMARY

According to one example of the present disclosure, a system can include a processor and a memory including instructions that are executable by the processor to perform operations. The operations can include detecting transmission of a resource request by a user device, the resource request being a request to transfer a resource from a first user account to a second user account via a resource system; identifying at least one standard associated with the resource system; receiving real-time data from the resource system, the real-time data being indicative of a workload of the resource system; generating a delay function comprising a duration of time based on the at least one standard and the real-time data; and executing the delay function to delay the transfer of the resource from the first user account to the second user account via the resource system for the duration of time.

According to another example of the present disclosure, a non-transitory computer readable medium may contain instructions that are executable by a processor to cause the processor to perform operations. The operations can include detecting transmission of a resource request by a user device, the resource request being a request to transfer a resource from a first user account to a second user account via a resource system; identifying at least one standard associated with the resource system; receiving real-time data from the resource system, the real-time data being indicative of a workload of the resource system; generating a delay function comprising a duration of time based on the at least one standard and the real-time data; and executing the delay function to delay the transfer of the resource from the first user account to the second user account via the resource system for the duration of time.

According to a further example of the present disclosure, a computer-implemented method can involve detecting transmission of a resource request by a user device, the resource request being a request to transfer a resource from a first user account to a second user account via a resource system; identifying at least one standard associated with the resource system; receiving real-time data from the resource system, the real-time data being indicative of a workload of the resource system; generating a delay function comprising a duration of time based on the at least one standard and the real-time data; and executing the delay function to delay the transfer of the resource from the first user account to the second user account via the resource system for the duration of time.

### BRIEF DESCRIPTION OF THE DRAWINGS

FIG. 1 is a block diagram of an example of a computing environment for controlling resource transfers based on resource system workloads and compliance standards according to some embodiments of the present disclosure.

FIG. 2 is a block diagram of an example of a computing device for controlling resource transfers based on resource system workloads and compliance standards according to some embodiments of the present disclosure.

FIG. 3 is a flowchart of an example of a process for controlling resource transfers based on resource system workloads and compliance standards according to some embodiments of the present disclosure.

### DETAILED DESCRIPTION

Certain aspects and examples of the present disclosure relate to controlling resource transfers based on resource system workloads and compliance standards. In one aspect, the system may generate a delay function in response to detecting transmission of a resource request by a user device. The resource request can be a request to transfer a resource (e.g., data) from a first user account to a second user account via a resource system. The delay function can be used to suspend execution of the resource request by the resource system for a duration of time. The delay function can be generated based on information included in the resource request, based on a standard associated with the resource system, or a combination thereof. For example, if the amount of data being transferred exceeds a threshold, the delay function may suspend execution of the resource request for more time than if the amount of data did not exceed the threshold.

Additionally, standards can represent regulatory requirements or guidelines imposed on an entity (e.g., a financial institution or a division within a financial institution) to provide stability, integrity, and accuracy in operations performed by the entity. The standards can be imposed on the entity by a regulatory authority, or the standards can be policies, rules, or the like imposed by the entity on itself. The standards can include requirements, which can define actions the entity can perform to satisfy the standards. In some examples, systems associated with the entity may be configured to satisfy the standards. For example, the system can control (e.g., delay) processing of a resource request at a resource system for at least a particular duration of time. The particular duration of time may be set forth in a requirement of a particular standard.

Resource systems may, upon receiving a request to transfer a resource, automatically process the request and perform the transfer of the resource. As a result, an influx of resource requests received by a resource system can cause network congestion. The network congestion can then cause latency, data loss, or otherwise degrade performance of the resource system. The influx of resource requests can further overload computational resources (e.g., CPU, memory, network bandwidth, or the like) associated with the resource system, which can also cause performance degradation for the resource system. Additionally, in some examples, a user may want to cancel a request transmitted via a user device to a resource system. For example, the request may have been initiated by an unauthorized user or the request may be inaccurate (e.g., for an incorrect amount or type of resource). Automatically processing an inaccurate or unauthorized request can result in loss of data, unauthorized data usage, and a reduction in data integrity. Moreover, when a requirement of a standard is modified or a new standard is imposed on an entity, software applications or services associated with the entity may become non-compliant with the standard. Being non-compliant with standards may leave the software applications or service vulnerable to security breaches or may have other undesirable effects.

Examples of the present disclosure can overcome one or more of the above-mentioned problems via the system that can control resource transfers based on standards for resource systems. The system may further control resource transfers based on information in a resource request, computing resource availability for the resource system, or a combination thereof. To control the resource transfers, the system can generate and execute a delay function to temporarily prevent a resource transfer from being performed at a resource system. As a result, the system can control an amount of resource requests being processed by a resource system within a given timeframe. The system may further use the delay functions to control a time between or an order of execution of a series of resource requests. In doing so, the system can reduce network congestion and prevent overloading of computing resources to improve performance (e.g., reduce latency) at the resource system.

Additionally, the system may generate the delay function in a dynamic manner based on requirements of a standard, information included in the resource request, computing resource availability, or a combination thereof. Therefore, if, for example, a standard is modified or a new standard is imposed on the entity that involves delaying resource requests, the system can generate the delay function accordingly. In this way, the system can facilitate entity compliance with new or modified standard requirements. The system can further enable users to transmit cancelation requests while temporarily delaying performance of a resource transfer. When the system receives a cancelation request, the system can terminate a corresponding delay function and prevent processing of the resource request. By enabling users to cancel resource request, the system can decrease loss of data, unauthorized data usage, and reductions in data integrity.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

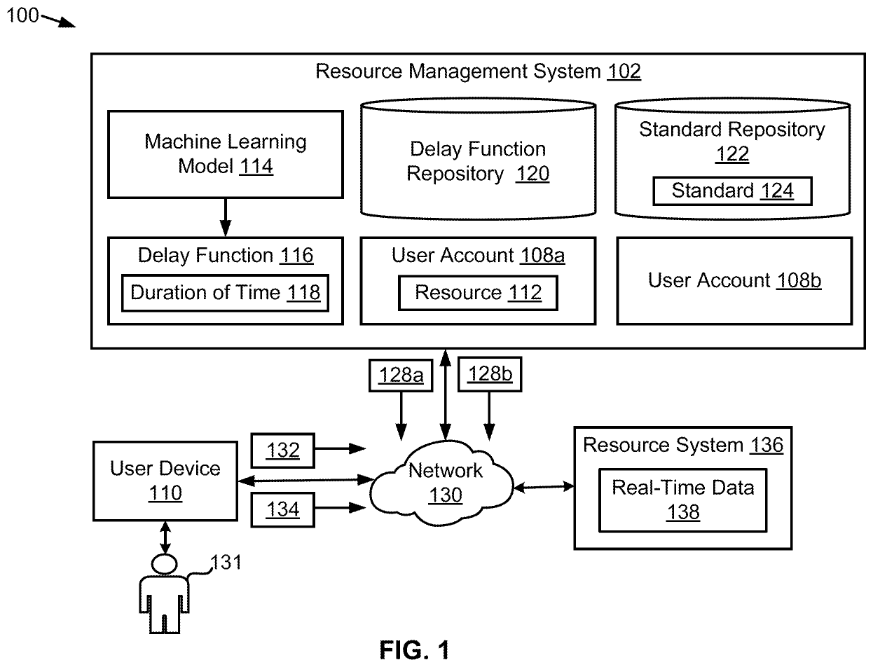

FIG. 1 is a block diagram of an example of a computing environment 100 for controlling resource transfers based on resource system workloads and compliance standards according to some embodiments of the present disclosure. The computing environment 100 can include a resource management system 102, which can be in communication with one or more user devices 110 and resource systems 136 via a network 130. Examples of the network 130 can include a local area network (LAN) or the Internet.

In some examples, the computing environment 100 may be a distributed computing environment, such as a cloud computing system, an IoT computing platform, or a computing cluster, formed from one or more nodes (e.g., physical or virtual servers) that are in communication with one another via the network 130. Additionally, in some examples, the computing environment 100 can be formed from a physical infrastructure that includes various network hardware, such as routers, hubs, bridges, switches, and firewalls. The physical infrastructure can also include one or more servers. The servers may provide backend support for a software application (e.g., a mobile application) or a web interface for enabling a user 131 to transmit requests to the resource system 104, the resource management system 102, or a combination thereof.

Additionally, in some examples, an entity (e.g., a financial institution) can be obligated to meet standards. For example, the standards may be regulatory standards or guidelines imposed on the entity by a regulatory authority or the standards can be policies, rules, restrictions, or the like set forth by the entity on to itself. The policies, rules, restrictions, etc. can be at least partially based on the regulatory standards and guidelines. Examples of the standards may include capital adequacy standards, liquidity standards, risk management standards, consumer protection standards, cybersecurity standards, etc. The standards can facilitate secure and efficient performance of various operations by the entity. For example, the standards can include requirements, which can define actions for the entity to perform to abide by or otherwise satisfy the standards. Requirements for the standards may include the entity implementing particular security policies, risk management protocols, or performing other suitable tasks. The requirements may further include the entity maintaining particular amounts or types of data. The standards and associated with requirements can be stored in a standard repository 122 associated with the resource management system 102. The standards can be organized in the standard repository 122 based on resource systems, user account types, or other suitable aspects of entity operations the standards are associated with.

In an example, the user 131 may establish a user account 108a with the entity. The user account 108a may be of any suitable type of account. For example, the entity may be a bank and the user account 108a may be a checking account, a savings account, or the like. Separately from establishing the user account 108a, the user 131 may register the user device 110 with the entity for use in authenticating, monitoring, or performing actions with respect to an associated user account 108a. For example, the user 131 can access the software application or web interface via the user device 110 to authenticate with, monitor, or perform actions with respect to the user account 108a. Examples of the user device 110 can include mobile phones, laptops, tablets, smart watches, etc.

Upon accessing the user account 108a via the software application executing on user device 110 or via the web interface, the user 131 can initiate resource transfers, which may involve a transfer of a resource from the user account 108a to another user account via a resource system 136 (e.g., Automated Clearing House (ACH), wire transfer, or the like). As a result of the user 131 initiating a resource transfer, the user device 110 can transmit a resource request to the resource system 136. The resource system 136 can be part of or communicatively coupled with the resource management system 102. The resource management system 102 can, in some examples, control the transmission of resource requests or subsequent processing of the resource requests at the resource system 136.

For example, the resource management system 102 can detect transmission of a resource request 132 by the user device 110. The resource request 132 can be a request to transfer a resource 112 (e.g., data, funds, or the like) from the first user account 108a to a second user account 108b via the resource system 136. In an example, the resource management system 102 can be configured as a proxy server, which may be conceptually positioned as an intermediary between the user device 110 and the resource system 136. As a result, the resource management system 102 may intercept and analyze the resource request 132 before passing the resource request on to the resource system 136.

Based on analyzing the resource request 132, the resource management system 102 can identify the resource system 136 (e.g., an international wire transfer system) associated with the resource request 132. The resource management system 102 may then access the standard repository 122 and identify a standard 124 associated with the resource system 136. In the example, the standard 124 stored in the standard repository 122 and associated with the resource system 136 can include a requirement that resource transfers transmitted to the resource system 136 be postponed for a particular duration of time. In particular, the requirement of the standard 124 can specify that international wire transfers be postponed for at least thirty minutes.

Additionally, in response to detecting the resource request 132 and identifying the resource system 136, the resource management system 102 may retrieve (e.g., request) real-time data 138 from the resource system 136. For example, the real-time data 138 can include information regarding resource requests currently being processed at the resource system 136 or that are scheduled to be processed at the resource system 136 over a subsequent timeframe (e.g., over the following hour). Such real-time data 138 can be indicative of a workload of the resource system 136. The workload can be a set of tasks the resource system 136 is performing or will perform over a period of time.

Additionally, the real-time data 138 can include statuses of resource requests recently received by the resource system 136 (e.g., resource requests received over a previous twenty-four-hour time frame). The statuses can involve an indication of whether resource transfers associated with each resource request were performed successfully via the resource system 126. If a resource transfer was not performed successfully, the real-time data 138 can further include an error associated with the resource transfer. The real-time data 138 may further include processing times for the recently received and successfully performed resource transfers. Thus, the real-time data 138 can be indicative of performance and computing resource usage (e.g., CPU usage and memory usage) of the resource system 136. For example, real-time data 138 with long processing times can indicate limited computing resource availability at the resource system 106.

After identifying the standard 124 and receiving the real-time data 138, the resource management system 103 can generate a delay function 116. The delay function 116 can include a duration of time 118. The duration of time 118 may be based on the standard 124, the real-time data 138, the resource request 132, or a combination thereof. For example, a minimum duration of time for the delay function 116 can be the particular duration of time indicated by the requirement of the standard 124 (e.g., thirty minutes). If the real-time data 138 indicates limited computing resource availability or that a current workload at the resource system 136 is significant, the duration of time 118 for the delay function 116 can be greater than the minimum duration. For example, the duration of time 118 can be one hour. The workload can be considered significant if a volume of resource requests being processed at or scheduled to be processed at the resource system 136 within a subsequent time frame exceeds a threshold. If the real-time data 138 does not indicate limited computing resource availability, a significant workload, or the like for the resource system 136, the delay function 116 can be generated with the minimum duration of time as set forth by the standard 124.

Additionally, in some examples, the duration of time 118 can be based on a type or amount of the resource 112 requested to be transferred. For example, if the amount of the resource (e.g., funds) exceeds a threshold (e.g., five hundred dollars), the duration of time 118 can be increased. If the amount of the resource does not exceed the threshold, the delay function 116 can be generated with the minimum duration of time. Moreover, in some examples, there may not be a standard associated with the resource system. In such examples, the delay function 116 can be generated based on the resource request, the real-time data, or a combination thereof.

Additionally or alternatively, the resource management system 102 may generate the delay function 116 using a machine learning model 114. The machine learning model 114 can be configured to output the delay function 116 based on the standard 124, the real-time data 138, the resource request 132, or a combination thereof. For example, the resource management system 102 can input the real-time data 138, information from the standard 124 (e.g., the requirement of postponing the resource transfer for thirty minutes), information from the resource request 132 (e.g., an amount or type of the resource 112 being transferred, the user account 108a from which the resource 112 may be transferred, and the user account 108b the resource 112 may be transferred too), or a combination thereof into the machine learning model 114. The machine learning model 114 can be trained using a set of standards for resource systems and corresponding delay functions. The machine learning model 114 can further be trained on resource request information and corresponding delay functions. Additionally, the machine learning model 114 can be trained on data indicative of resource system workloads, computing resource usage, or the like and corresponding delay functions. As a result, the machine learning model 114 can output the delay function 116 with the duration of time 118 based on receiving the real-time data 138, the information from the standard 124, the information from the resource request 132, or the combination thereof. The machine learning model 114 may be a regression model, decision tree, support vector machine, neural network, a combination thereof, or another suitable type of machine learning model.

After generating the delay function 116, the resource management system 102 can execute the delay function to delay the transfer of the resource 112 from the first user account 108a to the second user account 108b via the resource system 136 for the duration of time 118. For example, the resource management system 102 can insert the delay function 116 into a code base associated with the resource system 136. As a result, the delay function 116 can be executed prior to the resource system 136 executing the transfer of the resource 112 from the first user account 108a to the second user account 108b. Additionally or alternatively, executing the delay function can cause the resource management system 102 to hold the resource request 132 for the duration of time 118, thereby scheduling the forwarding of the resource request 132 to the resource system 136 for after the duration of time. Thus, after the duration of time 118 the resource system 136 may receive the resource request 132 from the resource management system 102 and perform the transfer of the resource 112.

During the duration of time, the resource management system 102 can transmit an alert 128a to the user device 110 to notify the user 131 of the user device 110 of the delay in processing of the resource request 132 caused by the delay function 116. The alert 128a can include details of the resource request 132, the duration of time 118, a combination thereof, or other suitable information. Additionally, after the duration of time, the resource management system 102 can detect a status of the transfer of the resource 112 from the first user account 108a to the second user account 108. The resource management system 102 may then transmit another alert 128b to the user device 110 to notify the user 131 of status of the resource transfer. For example, the alert 128b can indicate a successful transfer of the resource 112 to the second user account 108b or the alert 128b may indicate a failure to transfer the resource 112.

In some examples, after generating the delay function 116, the resource management system 102 can store the delay function 116 in a delay function repository 120. In this way, the delay function 116 can be used for similar resource requests. For example, the resource management system 102 can detect transmission of a second resource request by the user device 110, which can be another request to transfer the resource 112 from the first user account 108a to the second user account 108b via the resource system 136. In response, the resource management system 102 can retrieve the delay function 116 from the delay function repository 120 and automatically execute the delay function 116 to delay processing of the resource request via the resource system 136 for the duration of time 118.

Additionally or alternatively, upon receiving the second resource request, the resource management system 102 can receive additional real-time data for the resource system 136, which can be indicative of a current workload of the resource system 136. For example, due to the workload being a set of tasks the resource system 136 is performing or will perform over a period of time, the workload may be different at a time corresponding to the second resource request than at a time corresponding to the first resource request. Thus, the resource management system 102 may receive the additional real-time data indicative of the current workload, and may modify the delay function 116 based on the current workload. For example, the delay function 116 can be modified to increase or decrease the duration of time 118. The resource management system 102 can then execute the modified delay function to delay processing of the second resource request for a new duration of time.

Moreover, in some examples, the resource management system 102 can receive a cancelation request 134 from the user device 110 during the duration of time 118. In response, the resource management system 102 can terminate execution of the delay function 116 and prevent the transfer of the resource 112 by the resource system 136. For example, the resource management system 102 can prevent the transfer of the resource by not forwarding the resource request 132 to the resource system 136.

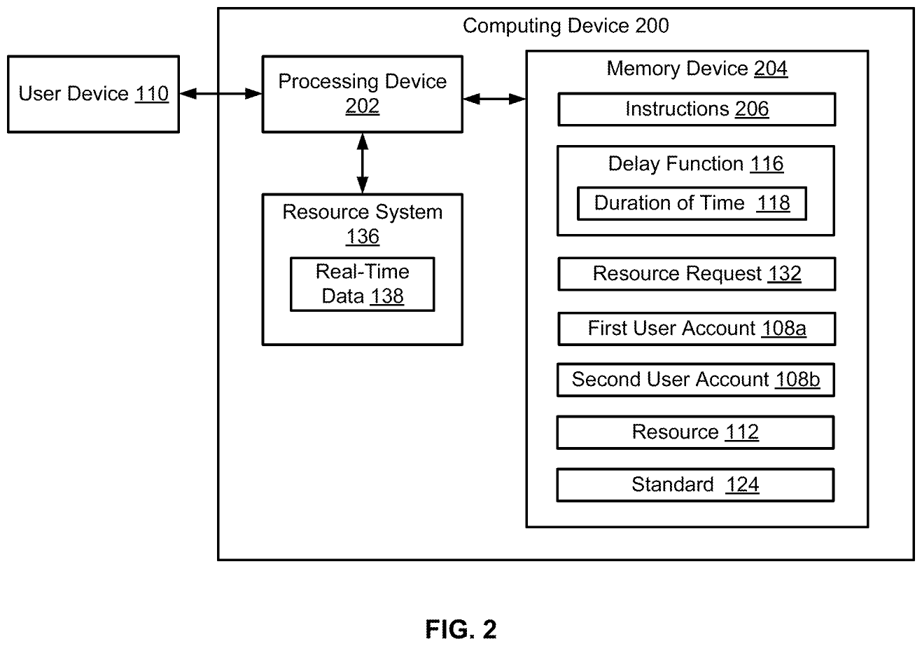

FIG. 2 is a block diagram of an example of a computing device 200 for controlling resource transfers based on resource system workloads and compliance standards according to some embodiments of the present disclosure. As depicted, the computing device 200 may include a processing device 202 communicatively coupled to a memory device 204. In some examples, the components shown in FIG. 2 can be integrated into a single structure. For example, the components can be within a single housing. In other examples, the components shown in FIG. 2 can be distributed (e.g., in separate housings) and in electrical communication with each other.

The processing device 202 can execute one or more operations for implementing some examples. The processing device 202 can execute instructions 206 stored in the memory device 204 to perform the operations. The processing device 202 can include one processing device or multiple processing devices. Non-limiting examples of the processing device 202 include a Field-Programmable Gate Array (“FPGA”), an application-specific integrated circuit (“ASIC”), a microprocessor, etc. In some examples, the instructions 206 can include processor-specific instructions generated by a compiler or an interpreter from code written in any suitable computer-programming language, such as C, C++, C#, Python, or Java.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can be a non-transitory, computer-readable medium from which the processing device 202 can read the instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which the processing device 202 can read the instructions 206.

The processing device 202 can execute the instructions 206 to perform operations. For example, the processing device 202 can detect transmission of a resource request 132 by a user device 110. The resource request 132 can be a request to transfer a resource 112 from the first user account 108a to a second user account 108b via a resource system 136. The processing device 202 can then identify at least one standard 124 associated with the resource system 136. The processing device 202 can also receive real-time data 138 from the resource system 136. The real-time data 138 can be indicative of a workload of the resource system 136. The processing device 202 can further generate a delay function 116 comprising a duration of time 118 based on the at least one standard 124 and the real-time data 138. Additionally, the processing device 202 can execute the delay function 116 to delay the transfer of the resource 112 from the first user account 108a to the second user account 108b via the resource system 136 for the duration of time 118.

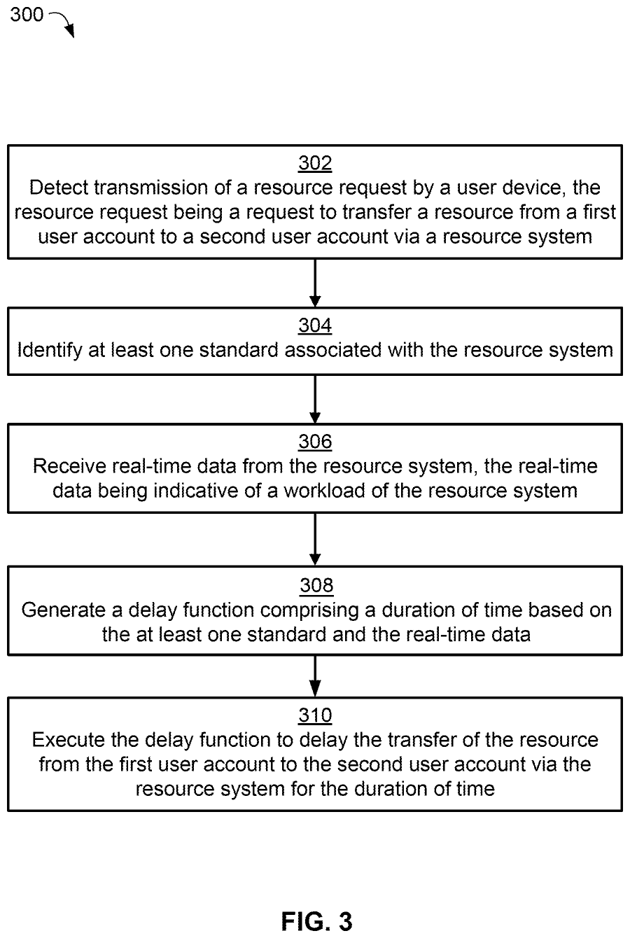

FIG. 3 is a flowchart of an example of a process 300 for controlling resource transfers based on resource system workloads and compliance standards according to some embodiments of the present disclosure. The process 300 can be implemented by the resource management system 102 of FIG. 1 or the computing device 200 of FIG. 2, but other implementations are also possible. While FIG. 3 depicts a certain sequence of steps for illustrative purposes, other examples can involve more steps, fewer steps, different steps, or a different order of the steps depicted in FIG. 3. The steps of FIG. 3 are described below with reference to the components of FIGS. 1-2 described above.

At block 302, the processing device 202 can detect transmission of a resource request 132 by a user device 110. The resource request 132 can be a request to transfer a resource 112 from a first user account 108a to a second user account 108b via a resource system 136. As a result of detecting transmission of the resource request 132, the processing device 202 can intercept and analyze the resource request 132 before passing the resource request on to the resource system 136.

At block 304, the processing device 202 can identify at least one standard 124 associated with the resource system 136. For example, the processing device 202 may access a standard repository 122 to identify the standard 124 associated with the resource system 136. The standard 124 stored in the standard repository 122 and associated with the resource system 136 can include a requirement that resource transfers transmitted via the resource system 136 be postponed for a particular duration of time.

At block 306, the processing device 202 can receive real-time data 138 from the resource system 136. The real-time data 138 can be indicative of a workload of the resource system 136. For example, the real-time data 138 can include information regarding resource requests currently being processed at the resource system 136 or that are scheduled to be processed at the resource system 136 over a subsequent timeframe (e.g., over the following half hour).

At block 308, the processing device 202 can generate a delay function 116 comprising a duration of time 118 based on the at least one standard 124 and the real-time data 138. For example, based on the standard 124, the duration of time 118 can be at least the particular duration of time (e.g., thirty minutes). Additionally, if the real-time data 138 indicates a volume of resource requests being processed at the resource system 136 over the next half hour exceeds a threshold, the duration of time can be increased. For example, the duration of time 118 can be increased to one hour.

At block 310, the processing device 202 can execute the delay function 116 to delay the transfer of the resource 112 from the first user account 108a to the second user account 108b via the resource system 126 for the duration of time 118. For example, executing the delay function can cause the processing device 202 to schedule a forwarding of the resource request 132 to the resource system 136 for after the duration of time. Then, after the duration of time 118 the resource system 136 may receive the resource request 132 from the processing device 202 and perform the transfer of the resource 112.

In one example, the processing device 202 can detect transmission of a resource request 132 by a user device 110. The resource request 132 can be a request to transfer transaction data from a first user account 108a to a second user account 108b via a resource system 136. The processing device 202 can then identify at least one standard 124 associated with the resource system 136. For example, the first user account 108a can be associated with a first entity and the second user account 108b can be associated with a second entity. The entities can be based in different countries. Thus, based on the resource request 132 being a request to transfer transaction data internationally, the processing device 202 can identify a standard 124 associated with the resource request 132. The standard 124 can specify that, when transferring transaction data internationally, the transfer of the transaction data should be delayed for at least thirty minutes from a time the resource request 132 was transmitted. The processing device 202 can further receive real-time data 138 from the resource system 136. The real-time data 138 can indicate a volume of transaction data transfers that are scheduled to be performed by the resource system 136 over a subsequent timeframe (e.g., the next three hours). Thus, the real-time data 138 can be indicative of a workload of the resource system 136. The processing device 202 can then input the real-time data 138 and information from the standard 124 (e.g., the specification that the transfer of transaction data should be delayed thirty minutes) into a machine learning model 114 configured to output a delay function 116. In this way, the processing device 202 can generate the delay function 116 based on the standard 124 and the real-time data 138 using the machine learning model 114. The delay function 116 can include a duration of time 118 (e.g., one hour) for delaying the transfer of the transaction data. The processing device 202 can then execute the delay function 116 to delay the transfer of the transaction data from the first user account 108a to the second user account 108b via the resource system 136 for the duration of time. In doing so, the processing device 202 can prevent the request from being forwarded to the resource system 136 for the duration of time 118. Then, after execution of the delay function 116, the resource request 132 can be forwarded to and processed at the resource system 136 to cause the transfer of transaction data from the first user account 108a to the second user account 108b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
detecting transmission of a resource request by a user device, the resource request being a request to transfer a resource from a first user account to a second user account via a resource system;
identifying at least one standard associated with the resource system;
receiving real-time data from the resource system, the real-time data being indicative of a workload of the resource system;
generating a delay function comprising a duration of time based on the at least one standard and the real-time data; and
executing the delay function to delay the transfer of the resource from the first user account to the second user account via the resource system for the duration of time.

2. The system of claim 1, wherein the operation of generating the delay function comprises executing a machine learning model configured to output the delay function based on the at least one standard and the real-time data.

3. The system of claim 1, wherein the operations further comprise transmitting an alert to the user device to notify a user of the user device of the delay in transferring the resource from the first user account to the second user account, wherein the alert comprises the duration of time.

4. The system of claim 3, wherein the operations further comprise, subsequent to executing the delay function:
detecting the transfer of the resource from the first user account to the second user account by the resource system; and
transmitting a second alert to notify the user of the user device of the transfer of the resource from the first user account to the second user account.

5. The system of claim 1, wherein the operations further comprise:
receiving a cancelation request from the user device during the duration of time; and
in response to receiving the cancelation request, terminating execution of the delay function and preventing the transfer of the resource from the first user account to the second user account via the resource system.

6. The system of claim 1, wherein the real-time data is first real-time data, the duration of time is a first duration of time, and wherein the operations further comprise, subsequent to executing the delay function:
detecting transmission of an additional resource request by the user device, the additional resource request being another request to transfer the resource from the first user account to the second user account via the resource system;
receiving second real-time data from the resource system, the second real-time data being indicative of the workload of the resource system;
modifying the delay function based on the second real-time data; and
executing the modified delay function to delay the transfer of the resource from the first user account to the second user account via the resource system for a second duration of time.

7. The system of claim 1, wherein the real-time data comprises data associated with a first plurality of resource requests being processed at the resource system and data associated with a second plurality of resource requests scheduled to be processed at the resource system during a subsequent timeframe.

8. A computer-implemented method comprising:
detecting transmission of a resource request by a user device, the resource request being a request to transfer a resource from a first user account to a second user account via a resource system;
identifying at least one standard associated with the resource system;
receiving real-time data from the resource system, the real-time data being indicative of a workload of the resource system;
generating a delay function comprising a duration of time based on the at least one standard and the real-time data; and
executing the delay function to delay the transfer of the resource from the first user account to the second user account via the resource system for the duration of time.

9. The computer-implemented method of claim 8, wherein generating the delay function comprises executing a machine learning model configured to output the delay function based on the at least one standard and the real-time data.

10. The computer-implemented method of claim 8, further comprising transmitting an alert to the user device to notify a user of the user device of the delay in transferring the resource from the first user account to the second user account, wherein the alert comprises the duration of time.

11. The computer-implemented method of claim 10, further comprising, subsequent to executing the delay function:
detecting the transfer of the resource from the first user account to the second user account by the resource system; and
transmitting a second alert to notify the user of the user device of the transfer of the resource from the first user account to the second user account.

12. The computer-implemented method of claim 8, further comprising:
receiving a cancelation request from the user device during the duration of time; and
in response to receiving the cancelation request, terminating execution of the delay function and preventing the transfer of the resource from the first user account to the second user account via the resource system.

13. The computer-implemented method of claim 8, wherein the real-time data is first real-time data, the duration of time is a first duration of time, and wherein the computer-implemented method further comprises, subsequent to executing the delay function:
detecting transmission of an additional resource request by the user device, the additional resource request being another request to transfer the resource from the first user account to the second user account via the resource system;
receiving second real-time data from the resource system, the second real-time data being indicative of the workload of the resource system;
modifying the delay function based on the second real-time data; and
executing the modified delay function to delay the transfer of the resource from the first user account to the second user account via the resource system for a second duration of time.

14. The computer-implemented method of claim 8, wherein the real-time data comprises data associated with a first plurality of resource requests being processed at the resource system and data associated with a second plurality of resource requests scheduled to be processed at the resource system during a subsequent timeframe.

15. A non-transitory computer-readable medium comprising instructions that are executable by a processing device for causing the processing device to perform operations comprising:
detecting transmission of a resource request by a user device, the resource request being a request to transfer a resource from a first user account to a second user account via a resource system;
identifying at least one standard associated with the resource system;
receiving real-time data from the resource system, the real-time data being indicative of a workload of the resource system;
generating a delay function comprising a duration of time based on the at least one standard and the real-time data; and
executing the delay function to delay the transfer of the resource from the first user account to the second user account via the resource system for the duration of time.

16. The non-transitory computer-readable medium of claim 15, wherein the operation of generating the delay function comprises executing a machine learning model configured to output the delay function based on the at least one standard and the real-time data.

17. The non-transitory computer-readable medium of claim 15, wherein the operations further comprise transmitting an alert to the user device to notify a user of the user device of the delay in transferring the resource from the first user account to the second user account, wherein the alert comprises the duration of time.

18. The non-transitory computer-readable medium of claim 17, wherein the operations further comprise, subsequent to executing the delay function:
detecting the transfer of the resource from the first user account to the second user account by the resource system; and
transmitting a second alert to notify the user of the user device of the transfer of the resource from the first user account to the second user account.

19. The non-transitory computer-readable medium of claim 15, wherein the operations further comprise:
receiving a cancelation request from the user device during the duration of time; and
in response to receiving the cancelation request, terminating execution of the delay function and preventing the transfer of the resource from the first user account to the second user account via the resource system.

20. The non-transitory computer-readable medium of claim 15, wherein the real-time data is first real-time data, the duration of time is a first duration of time, and wherein the operations further comprise, subsequent to executing the delay function:
detecting transmission of an additional resource request by the user device, the additional resource request being another request to transfer the resource from the first user account to the second user account via the resource system;
receiving second real-time data from the resource system, the second real-time data being indicative of the workload of the resource system;
modifying the delay function based on the second real-time data; and
executing the modified delay function to delay the transfer of the resource from the first user account to the second user account via the resource system for a second duration of time.
